(19) United States
(12) Patent Application Publication
(10) Pub. No.: US 2008/0283569 A1
(43) Pub. Date: Nov. 20, 2008

(54) Expulsion Device Actuated by a Pressure Medium

(76) Inventor: Gerhard Kral, Schotten (DE)

Correspondence Address: QUARLES & BRADY LLP, 411 E. WISCONSIN AVENUE, SUITE 2040, MILWAUKEE, WI, 53202-4497, US

(21) Appl. No.: 11/817,587

(22) PCT Filed: Oct. 11, 2005
(86) PCT No.: PCT/EP2005/010925

§ 371 Date: Apr. 23, 2008

(30) Foreign Application Priority Data
Mar. 3, 2005 (DE) 20 2005 003 422.3

(51) Int. Cl. B25C 1/04

(52) U.S. Cl. 227/130

(57) ABSTRACT

The invention relates to an expulsion device which is actuated by a pressure medium and which is used to expel objects or liquid materials from a reservoir by means of a drive piston which is impinged upon by a pressure medium, comprising a pressure medium container which is exchangeable via a pressure connection device and which connected to a drive device, enabling the pressure medium to impinge upon the drive piston which is used to connect the pressure medium container (23) and a stationary pressure source.

The present invention relates to an expulsion device operated by a pressure medium, for expelling objects or fluid materials from a reservoir using a propulsion piston impinged by a pressure medium having a pressure medium store replaceably connected via a pressure attachment device to the expulsion device for the pressure medium impingement of the propulsion piston.

A device of the type cited at the beginning in the embodiment as an impact device for driving mechanical fasteners, such as steel nails, is known from WO 03/002308 A1. In the known device, the pressure medium store is attached directly to a device element of the expulsion device. The pressure medium store allows mains-independent operation of the expulsion device, so that the expulsion device does not have to be attached to a stationary pressure source for its operation. This allows significantly simplified handling of the expulsion device in particular in cases in which frequent position changes are to be performed using the expulsion device. In other usage cases, in which the operation of the expulsion device predominantly occurs in an unchanged position or the mechanical fasteners may only be driven with a very high force expenditure, however, it may prove to be advantageous to use an expulsion device which is attached to a stationary compressed air source, because in these cases the limited volume of a pressure medium store would only allow a correspondingly brief operating time of the expulsion device.

To allow the particular more favorable operating conditions for the user depending on the usage conditions, up to this point it has been necessary to select between an expulsion device provided with a pressure medium store and an expulsion device suitable for attachment to a stationary compressed air source, so that at least two accordingly differently implemented expulsion devices are to be provided, with the correspondingly high provision costs connected thereto.

The present invention is based on the object of reducing the provision outlay for performing work performable using expulsion devices operated by a pressure medium.

To achieve this object, the expulsion device according to the present invention has a pressure attachment device, which is used both for attachment to the pressure medium store and also attachment to a stationary pressure source.

Therefore, according to the present invention, an expulsion device is suggested which, depending on the working or usage conditions, allows both mains operation, i.e., operation connected to a stationary pressure source, and also mains-independent operation, i.e., operation based on the compressed air reservoir defined by the pressure medium store.

In an especially preferred embodiment of the expulsion device, the pressure attachment device has a pressure reduction unit, which may be impinged with pressure by both the pressure medium store and also the stationary pressure source. In this way, in the event of a preset operating pressure for operating the expulsion device, one may select arbitrarily between the attachment to the stationary pressure source or the pressure medium store, without having to change a setting of the operating pressure which has been adapted once to the working conditions.

If the pressure reduction unit is attached to a pressure chamber, which is connectable via a first pressure connection to the pressure medium store and via a second pressure connection to the stationary pressure source, it is ensured that both the store pressure generated by the compressed air reservoir of the pressure medium store and also the mains pressure generated by the stationary pressure act on the pressure reduction unit in the same way.

If a further pressure reduction unit is situated in the pressure connection between the pressure reduction unit and the pressure medium store, it may be ensured that in the event of a change between the pressure medium store pressure and the mains pressure for operating the expulsion device, no harmful pressure peaks may occur.

It has been proven to be especially advantageous if the pressure attachment device has a device attachment element and a store attachment element, which are connected to one another via a pressure line, the device attachment element being used for attachment to the expulsion device and the store attachment element being used for attachment to the pressure medium store. It is thus possible to provide separate attachment units for implementing the pressure attachment device, which may be situated at independent locations from one another in the particular most favorable positions on the expulsion device.

If the device attachment element is additionally used for situating a pressure attachment for the stationary pressure source and for situating the first pressure reduction unit and the store attachment element is used for situating a pressure attachment for the pressure medium store and for situating the second pressure reduction unit, direct assignment of the pressure reduction units to the units of the expulsion device working together therewith is possible, so that, for example, operating errors of the expulsion device due to confusion of the pressure reduction units are to be precluded.

If the store attachment element is implemented as a support bracket for accommodating the pressure medium store, the store attachment element simultaneously fulfills the function of a mechanical coupling unit for connecting the pressure medium store to the expulsion device.

If the store attachment element is additionally situated on a magazine device connected to a device element of the expulsion device, the device element of the expulsion device itself may be designed identically to a device element of an expulsion device which is exclusively intended to be connected to a stationary compressed air source.

It has been proven to be especially advantageous in regard to the handling of the expulsion device if the store attachment element is situated in such a way on the magazine device that the pressure medium store extends along the magazine device, so that the overall volume of the expulsion device provided with a pressure medium store essentially does not differ from the overall volume of an expulsion device intended to be attachment exclusively to a stationary compressed air source.

It has an especially advantageous effect on the operational reliability of the expulsion device if the pressure medium store at least partially extends through a protector unit connected to the magazine device, so that the pressure medium store is protected from external damage. In addition, depending on the implementation of the protector unit, it may also contribute to the static support of the pressure medium store.

A protector unit which is formed by a bow unit extending peripherally to the cross-sectional circumference has been shown to be especially simple in design and especially effective in its action.

A preferred embodiment of the expulsion device is explained in greater detail in the following on the basis of the drawings.

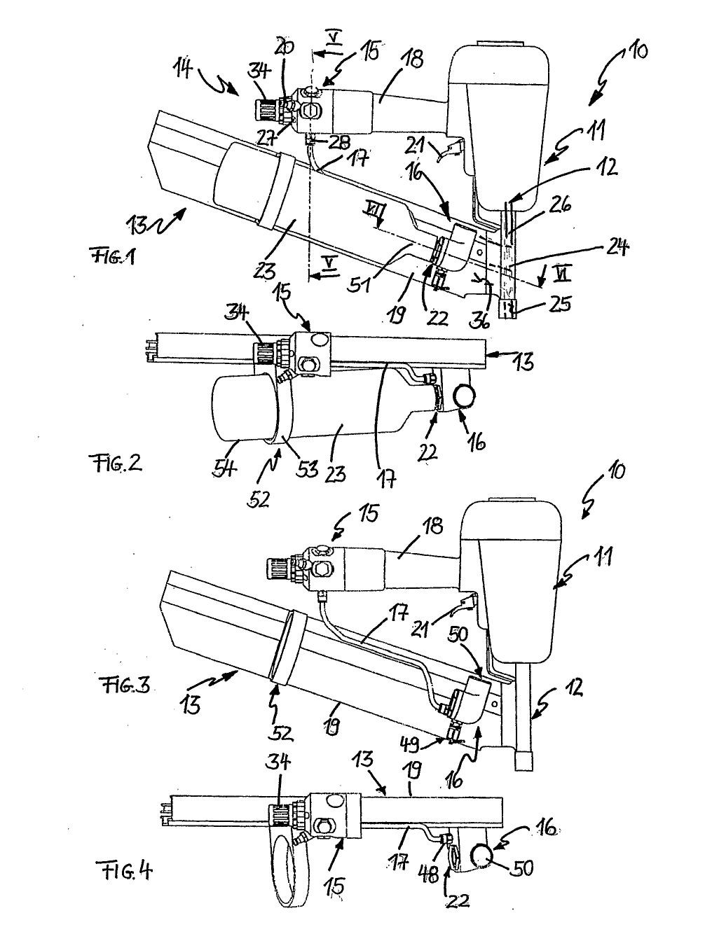

FIG. 1 shows an expulsion device having a magazine device situated on a device element and an installed pressure medium store in a side view;

FIG. 2 shows the expulsion device shown in FIG. 1 in a top view and without the device element;

FIG. 3 shows the expulsion device shown in FIG. 1 without the pressure medium store;

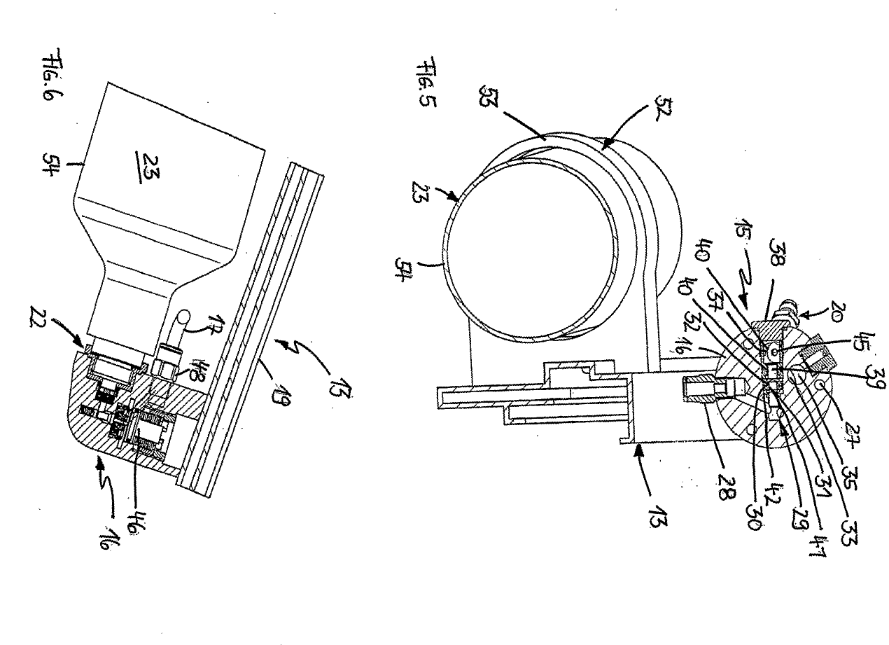

FIG. 4 shows the expulsion device shown in FIG. 2 without the pressure medium store;

FIG. 5 shows a sectional illustration of the expulsion device shown in FIG. 1 along section line V-V;

FIG. 6 shows the expulsion device shown in FIG. 1 behind the sectional illustration along section line VI-VI.

FIG. 1 shows an expulsion device 10 having a device element 11, which has a drive piston unit 12 on its lower end area. A magazine device 13 is attached to the device element 11 in the area of the drive piston unit 12.

The expulsion device 10 is provided with a pressure attachment device 14, which has a device attachment element 15 and a store attachment element 16 in the exemplary embodiment shown in FIG. 1, which are connected to one another via a pressure line 17. The device attachment element 15 is attached to a handle part 18 of the device element 11 and the store attachment element 16 is situated on a magazine housing 19 of the magazine device 13.

A pressure attachment 20, implemented here as a connecting part, is provided on the device attachment element 15 for the pressure medium supply in the exemplary embodiment in FIG. 1, which is used for the connection to a stationary compressed air source, i.e., a compressor unit, for example, via a mains connection line (not shown in greater detail here). A expulsion pin 26 of the drive piston unit 12 of the expulsion device 10 may be impinged with operating pressure via the pressure attachment 20 using a pressure line unit (not shown in greater detail here), which connects the pressure attachment 20 through the device attachment element 15 and the device element 11 to the drive piston unit 12. The impingement of the expulsion pin 26 is triggered via an actuation of a trigger lever 21 situated on the device element 11.

The store attachment element 16 situated on the magazine device 13 is connected via a pressure attachment 22 to a pressure medium store 23, which contains compressed air having a storage pressure of approximately 300 bar in the present case. A pressure connection exists between the compressed air reservoir accommodated in the pressure medium store 23 and the device attachment element 15, which, as explained above, is connected via a pressure connection to the drive piston unit 12, via the pressure attachment 22, the store attachment element 16, and the pressure line 17.

The magazine device 13 has a number of steel nails 24 situated in a row composite in a housing channel 36 of the magazine housing 19 (only indicated by dashed lines here), which are each situated with their longitudinal axis parallel to the axis of an expulsion channel 25 and are forced into a final position in the expulsion channel 25 via an axial propulsion unit (not shown in greater detail here) situated in the magazine device 13. Upon applied operating pressure, the steel nails 24 are impinged by the expulsion pin 26 of the drive piston unit 12 due to an actuation of the trigger lever 21, so that the steel nail 24 is driven out of the expulsion channel 25.

As FIG. 1 shows in particular, the device attachment element 15 is connected by a flange to the free end of the handle part 18 and has three fastening holes 27 for this purpose, as shown in FIG. 5, which are used for guiding through fastening screws (not shown in greater detail). As is also clear from viewing FIGS. 1, 4, and 5 together, the device attachment element 15 has, in addition to the pressure attachment 20, which is used for the connection to a stationary compressed air source, a pressure attachment 28, which is used to attach the pressure medium store 23 to the device attachment element 15 via the pressure line 17 connected thereto. The pressure attachment 20 and the pressure attachment 28 are connected to one another via a valve unit 29 situated in the device attachment element 15, which, depending on the switch position of its valve element 30, allows a compressed air connection between the pressure attachment 28 and an operating pressure channel 31 leading to the drive piston unit 12 of the expulsion device 10 or the pressure attachment 20 and the operating pressure channel 31. The operating pressure channel 31 discharges into a valve chamber 32, in which the valve element 30 is movable between two switch positions, in the illustration shown in FIG. 5. A pressure reduction unit 34 illustrated in FIG. 1 is connected to a pressure chamber 33 situated behind the valve unit 29 in the illustration shown in FIG. 5. Finally, an operating pressure channel 35, which continues through the handle part 18 of to the drive piston unit 12 to impinge the expulsion pin 26 with operating pressure, discharges into the pressure chamber 33.

The valve chamber 32 is implemented in a housing hole 37 of the device attachment element 15, which is closed to the outside by a hole stopper 38. A sleeve-shaped valve seat element 40 a situated in the housing hole 37, which is pressed against a hole shoulder 41 by a spacer sleeve 39 situated between the hole stopper 38 and the valve seat element 40 for positioning. A further hole shoulder, which is used as a housing valve seat 42, is implemented on the diametrically opposite side of the valve chamber 32. The switch positions of the valve element 30 are thus defined by contact of the valve element against the valve seat part 39 on one hand and by contact of the valve seat element against the housing valve seat 42 on the other hand. In the embodiment shown in FIG. 5, the valve element has a valve element implemented as a cylindrical pin having a valve seal 44 situated radially thereon. The sleeve is provided with wall holes 45, which allow a fluid connection to the pressure attachment 20, for the fluid connection between the pressure attachment 20 and the valve chamber 32.

To uniquely define a specific switch position in the case of pressure impingement of the pressure attachment 20 and the pressure attachment 28, the valve pressure via the pressure attachment 28 from the pressure medium store 23 is fundamentally set higher using a pressure reduction unit 46 situated in the store attachment element 16, as shown in FIG. 6, than the valve pressure acting on the valve element 30 from the stationary compressed air source via the pressure attachment 20. For example, the pressure applied to the pressure attachment 28 may be set to 15 bar, which is thus higher than the pressure of a stationary compressed air source, which is typically set to 8 bar.

As shown by viewing FIGS. 3, 4, and 6 together, the store attachment element 16 situated on the magazine housing 19 of the magazine device 13 is provided, in addition to the pressure reduction unit 46, which is situated in a fluid connection between the pressure attachment 22 and an attachment connecting part 48 for the pressure line 17, with a safety valve 49 for interrupting a pressure connection between the pressure medium store 23 and the pressure reduction unit 46. In addition, the store attachment element 16 is also provided in the present case with a fill level indicator 50 for indicating the current volume contained in the pressure medium store 23.

The device attachment element 15 shown in FIG. 5 allows a simultaneous attachment of both the pressure medium store 23 to the pressure attachment 28 and a stationary compressed air source to the pressure attachment 20 via the valve unit 29, the valve pressure caused by the pressure medium store 23, which is settable comparatively higher using the pressure reduction unit 46, uniquely defining a pressure supply of the drive piston unit 12 via the pressure medium store 23 in this case. In addition, of course, it is possible to impinge only the pressure attachment 20 or the pressure attachment 28 with pressure.

As is obvious from FIGS. 1 and 2, the pressure medium store 23 is connected at its attachment end 51 to the pressure attachment 22 of the store attachment element 16 in such a way that it extends along the magazine device 13. The store attachment element 16, which is rigidly connected to the magazine housing 19 of the magazine device 13 in a way not shown in greater detail, is also used as a support bracket which essentially assumes the mechanical support of the pressure medium store 23. A protector unit 52 is also located on the magazine housing 19, which has a receptacle ring 53, into which the cylindrical element 54 of the pressure medium store 23 is inserted. Depending on the selected fit between the internal diameter of the receptacle ring 53 and the external diameter of the cylindrical element 54, the receptacle ring 53 may support the pressure medium store 23 in addition to the store attachment element 16 or may only form a protection ring around the cylindrical element 54, which protects the pressure medium store 23 from impacts, such as those caused by laying the expulsion device 10 on a support surface. In the configuration of the pressure medium store 23 on the magazine device 13 shown in FIG. 1, the magazine housing 19 also has a supplementary protector function, because the pressure medium store 23 is situated inside the width extension of the magazine housing 19.

### LIST OF REFERENCE NUMERALS

10 expulsion device
11 device element
12 drive piston unit
13 magazine device
14 pressure attachment device
14 device attachment element
16 store attachment element:
17 pressure line
18 handle part
19 magazine housing
20 pressure attachment
21 trigger lever
22 pressure attachment
23 pressure medium store
24 steel nail
25 expulsion channel
26 expulsion pin
27 fastening hole
28 pressure attachment
29 valve unit
30 valve element
31 operating pressure line
32 valve chamber
33 pressure chamber
34 pressure reduction unit
35 operating pressure channel
36 drive piston
37 housing hole
38 hole stopper
39 valve seat part
40 spacer sleeve
41 hole shoulder
42 housing valve seat
43 valve element
44 valve seal
45 wall hole
46 pressure reduction unit
47 store attachment unit
48 store connecting part
49 safety valve
50 fill level indicator
51 connection end
52 protector unit
53 receptacle ring
54 cylindrical element

1. An expulsion device operated by a pressure medium for expelling objects or fluid materials from a reservoir using a drive piston impinged by a pressure medium having a pressure medium store replaceably connected via a pressure attachment device to the expulsion device for pressure medium impingement of the drive piston,
wherein
the pressure attachment device is used both for attachment of the pressure medium store and also for connection to a stationary pressure source.

2. The expulsion device according to claim 1,
wherein
the pressure attachment device has a pressure reduction unit, which may be impinged by pressure from both the pressure medium store and also from the stationary pressure source.

3. The expulsion device according to claim 2,
wherein
the pressure reduction unit is connected to a pressure chamber, which is connected via a first pressure connection to the pressure medium store and via a second pressure connection to the stationary pressure source.

4. The expulsion device according to claim 1,
wherein
a further pressure reduction unit is situated in the pressure connection between the pressure reduction unit and the pressure medium store.

5. The expulsion device according to claim 1,
wherein
the pressure attachment device has a device attachment element and a store attachment element, which are connected to one another via a pressure line, the device attachment element being used for attachment to the expulsion device and the store attachment element being used for connection to the pressure medium store.

6. The expulsion device according to claim 5,
wherein
the device attachment element is used for situating a pressure attachment for the stationary pressure source and for situating the first pressure reduction unit, and the store attachment element is used for situating a pressure attachment for the pressure medium store and for situating the second pressure reduction unit.

7. The expulsion device according to claim 6,
wherein
the store attachment element is implemented as a support bracket for accommodating the pressure medium store.

8. The expulsion device according to claim 7,
wherein
the store attachment element is situated on a magazine device connected to a device element of the expulsion device.

9. An expulsion device operated by a pressure medium for expelling objects or fluid materials from a reservoir using a drive piston impinged by pressure medium having a pressure medium store replaceably connected to the expulsion device via a pressure attachment device for impinging the drive piston with pressure medium,
wherein
the pressure attachment device is used both for attachment of the pressure medium store and also for attachment to a stationary pressure source.

10. The expulsion device according to claim 1,
wherein
the pressure attachment device has a pressure reduction unit, which may be impinged with pressure from both the pressure medium store and also from the stationary pressure source.

11. The expulsion device according to claim 2,
wherein
the pressure reduction unit is attached to a pressure chamber, which is connected via a first pressure attachment to the pressure medium store and via a second pressure attachment to the stationary pressure source.
